(19) United States
(12) Patent Application Publication
(10) Pub. No.: US 2008/0014120 A1
(43) Pub. Date: Jan. 17, 2008

(54) Biosensing device

(75) Inventors: Murphy Chiu, Hsinchu (TW); Wen Ching Yuan, Hsin-Chu City (TW)

Correspondence Address: BIRCH STEWART KOLASCH & BIRCH, PO BOX 747, FALLS CHURCH, VA, 22040-0747, US

(73) Assignee: EPS Bio Technology Corp.

(21) Appl. No.: 11/514,849

(22) Filed: Sep. 5, 2006

(30) Foreign Application Priority Data
Jul. 17, 2006 (TW) 095125973

(51) Int. Cl. G01N 21/00

(52) U.S. Cl. 422/82.05

(57) ABSTRACT

A biosensing device includes: a routing matrix, electrically connected to a testing strip; a sensors and actuators group, electrically connected to the routing matrix; a processing module, electrically connected to the routing matrix, and an in-system programming interface. The processing module includes a processing unit and a storage device storing application software. The in-system programming interface is electrically connected to the processing module, for connecting to an external in-system programmer and utilizing the in-system programmer to update the application software; wherein the processing unit executes the application software, updated through in-system programming interface, to control the sensors and actuators group for measuring the testing strip to generate a biosensing result.

### BACKGROUND OF THE INVENTION

1. Field of the Invention

The present invention relates to a biosensing device, and more particularly, to a biosensing device, which has an in-system programming interface, capable of utilizing an external in-system programmer through the in-system programming interface in order to arrange the inner components of the biosensing device such that different functions can be achieved or different algorithms can be executed.

1. Description of the Related Art

In general, a biosensing device is utilized to measure the concentration of biological materials (for example, blood glucose concentration) in humans' blood. Therefore, a diabetic can monitor his blood glucose concentration by using the biosensing device to maintain his health.

U.S. Pat. No. 5,366,609 discloses a biosensing device, which utilizes a read-only-memory key (ROM key) to select a specific biosensing procedure to be executed or to provide parameters for biosensing procedures to achieve the purpose of measuring the concentration. For example, when different testing strips (testing samples) are plugged into the biosensing device, different ROM keys can be used to inform the biosensing device to execute a corresponding biosensing procedure according to different testing strips or to execute the biosensing procedure according to different parameters.

As mentioned previously, it can be seen that the above-mentioned biosensing device is flexible because it can utilize the ROM keys to adjust the procedure and the operation according to the selected procedure or the parameters. But the adjusting mechanism only allows the user to select one of previously arranged procedures or determine the parameter utilized in the operations. In other words, even the above-mentioned biosensing device can utilize a ROM key, the bisensing device still cannot execute the procedures, which are not previously embedded inside the memory. That is, the above-mentioned biosensing device is not expandable. If a new type of testing strip appears in the market, the consumer needs to buy another biosensing device, which supports the new testing strip, to perform the measurement operation corresponding to the new testing strip.

### SUMMARY OF THE INVENTION

In view of the above-mentioned problems, an object of the invention is to provide a expandable biosensing device capable of updating the software in the memory through an in-system programming interface to support a new function and a new testing strip, to further solve the above-mentioned problem.

According to an embodiment of the present invention, a biosensing device for measuring a testing strip to generate a measurement result is disclosed. The biosensing device comprises: a sensors and actuators group; a processing module comprising: a storage device storing an application software; and a processing unit, electrically connected to the storage device; a routing matrix, comprising a plurality of connecting ends and a plurality of switch devices, the plurality of connecting ends are respectively electrically connected to the testing strip, the processing module, and the sensors and actuators group; and an in-system programming interface, electrically connected to the processing module, for connecting to an in-system programmer to utilize the in-system programmer to update the application software; wherein the processing unit executes the updated application software updated by the in-system programmer to control the plurality of switch devices inside the routing matrix to change electrical connections among the sensors and actuators group, the processing module, and the testing strip in order to utilize the sensors and actuators group to measure the testing strip and process a sensing result of the sensors and actuators group to generate the measuring result.

The present invention biosensing device comprises an in-system programming interface capable of utilizing an external in-system programmer to update the application software inside the memory. Therefore, the present invention can support different kinds of testing strips or provide other functions (e.g: flashlight or IR transmission functions) after it is updated. For example, after the present invention biosensing device has already been developed, if a new testing strip appears, the present invention can support the new testing strip by updating the application software through the in-system programming interface as long as the new testing strip can work with the biosensing device (this means that the pins of the new testing strip can comply with the pin interface of the biosensing device and the original inner devices inside the biosensing device are enough for the new testing strip).

### BRIEF DESCRIPTION OF THE DRAWINGS

FIG. 1 is a diagram of a biosensing device of an embodiment according to the present invention.

FIG. 2 is a circuit diagram of an embodiment of the routing matrix 130 shown in FIG. 1.

FIG. 3 is a diagram of different testing strips.

### DETAILED DESCRIPTION OF THE INVENTION

The “TITLE” of the invention will be described with reference to the accompanying drawings.

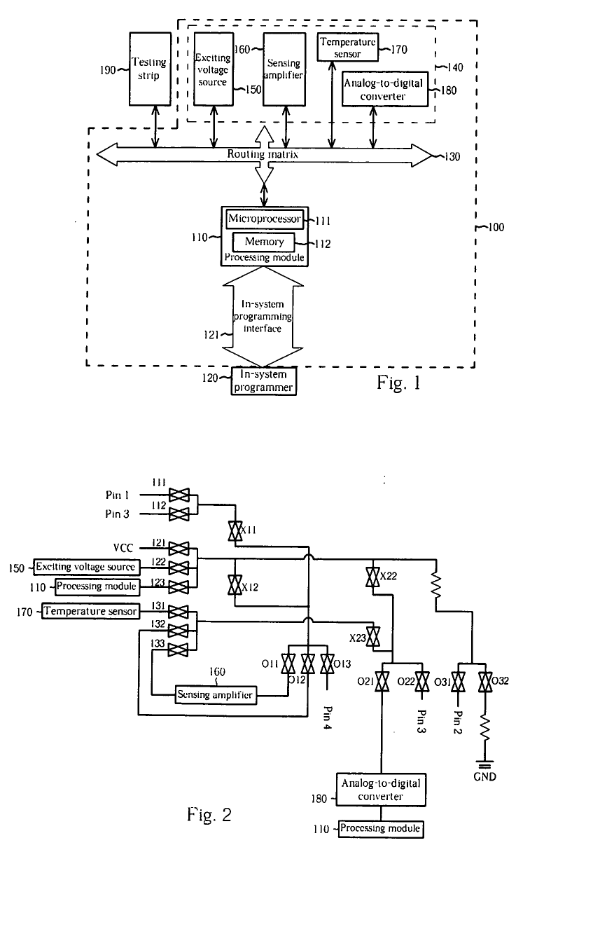

Please refer to FIG. 1, which is a diagram of a biosensing device 100 of an embodiment according to the present invention. As shown in FIG. 1, the biosensing device 100 comprises a processing module 110, an in-system programming interface 121, a routing matrix 130, and a sensors and actuators group 140. The sensors and actuators group 140 comprises an exciting voltage source 150, a sensing amplifier 160, a temperature sensor 170, and an analog-to-digital converter 180.

In addition, the processing module 110 comprises a microprocessor 111 and a memory 112 electrically connected to the microprocessor 111. The memory 112 stores application software. Please note that, the processing module 110, the exciting voltage source 150, the sensing amplifier 160, the temperature sensor 170, the A/D converter 180, and a testing strip 190 to be measured are respectively electrically connected to the routing matrix 130. Furthermore, an external in-system programmer 120 is electrically connected to the processing module 110 through the above-mentioned in-system programming interface (such as JTAG interface) 121. And the operations and functions of the inner devices of the biosensing device 100 will be illustrated in the following disclosure.

Please refer to FIG. 2, which is a circuit diagram of an embodiment of the routing matrix 130 shown in FIG. 1. As shown in FIG. 2, the routing matrix 130 comprises a plurality of transmission gates I11-I33, X11-X23, and O11-O32, and a plurality of connecting ends. The connecting ends are respectively electrically connected to the above-mentioned inner devices and the pins 1-4 of the testing strip 190. It should be noticed that, the electrical connections among the devices and the routing matrix 130 are shown in FIG. 2, and further illustrations are thus omitted here.

From FIG. 2, it can be seen that the routing matrix 130 can change the circuit configuration (change the electrical connections among the inner devices of the biosensing device 100) according to the conditions of each of the transmission gates I11-I33, X11-X23, and O11-O32. In this embodiment, the processing module 110 is coupled to each of the transmission gates I11-I33, X11-X23, and O11-O32 (not shown) to control the conducting condition of each transmission gate in order to further control the circuit configuration of the entire routing matrix 130.

Therefore, the present invention biosensing device 100 not only can perform the predetermined function, but also can arrange the devices inside the biosensing device 100 through the routing matrix 130 such that another function can be performed. As mentioned previously, after the biosensing device 100 is developed, a new testing strip, which the biosensing device 100 does not support, may appear in the market. Please note that the prior art biosensing device is impossible to support the new testing strip, so the consumer needs to buy a new biosensing device supporting the new testing strip.

However, the present invention biosensing device 100 is not limited by the above-mentioned limitation. As long as the new testing strip can work with the biosensing device 100 (this means that the pins of the new testing strip can comply with the pin interface of the biosensing device 100 and the original inner devices inside and the inner devices of the biosensing device 100 is enough for the new testing strip), the biosensing device 100 can be updated to support the new testing strip.

The aforementioned in-system programming interface 121 is utilized to update the biosensing device 100. As mentioned previously, the in-system programming interface 121 is coupled between the external in-system programmer 120 and the processing module 110. Therefore, the in-system programmer 120 can update the application software stored inside the memory 112 through the in-system programming interface 121. In this way, when the microprocessor 111 executes the updated application software, the microprocessor 111 can control the transmission gates inside the routing matrix 130 according to the updated application software. This allows the microprocessor 111 to further control the electrical connections among the sensors and actuators group 140, the processing module 110, and the testing strip 190 such that a brand new function (e.g: to measure a new testing strip) of the biosensing device 100 can be provided.

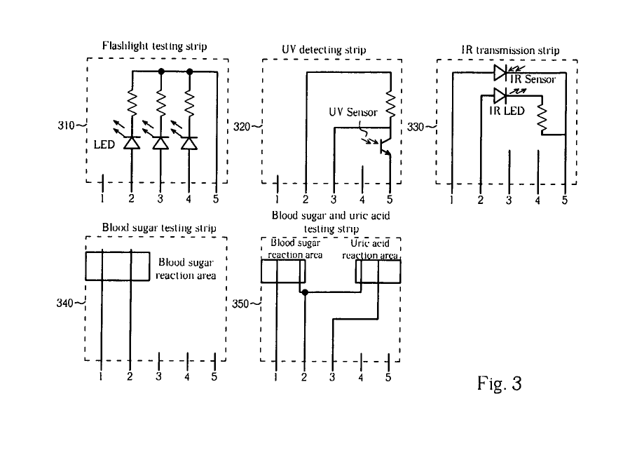

Please refer to FIG. 3, which is a diagram of different testing strips 310-350. Here, we assume that these testing strips 310-350 are all new testing strips (in other words, the original biosensing device 100 does not support the testing strips 310-350 at first). In the following disclosure, the present invention will illustrate how to utilize(update) the original structure of the biosensing device 100 to support the operation of each of the testing strips 310-350.

Please refer to FIG. 3 in conjunction with FIG. 2. First, for the flashlight testing strip 310, the flashlight testing strip 310 comprises three LEDs (light emitting diodes), which are respectively connected to pins 2-4. As the name of the flashlight testing strip 310 implies, the testing strip 310 can allow the biosensing device 100 to be utilized as a flashlight. Here, we assume that the biosensing device 100 cannot support the flashlight testing strip 310 in the beginning (before being updated). Therefore, in order to support the flashlight testing strip 310, the in-system programmer 120 has to update the application software stored inside the memory 112 through the in-system programming interface 121. For example, the in-system programmer 120 can additionally burn the program codes, which can be utilized to support the testing strip 310, into the memory 112 through the in-system programming interface 121.

Therefore, in this embodiment, the microprocessor 111 executes the updated application software to turn on the transmission gates I21, X12, X22, O13, O22, and O31. In this way, the external voltage source Vcc is applied to the three LEDs of the testing strip 310. Therefore, the three LEDs generate lights inside the routing matrix 130 such that the entire biosensing device 100 can be utilized as a flashlight.

In addition, if the luminance of the flashlight testing strip 310 should be reduced, the microprocessor 111 can execute the updated application software (for example, the user can utilize the updated application to set up the luminance according to his demand) to turn on the transmission gates I21, X12, X22, O13, O22, and O32 inside the routing matrix 130. In this way, only two LEDs, connected to the pins 3-4, are biased to generate lights, and the luminance of the testing strip 310 can be therefore reduced.

For the UV detecting strip 320, as the name implies, the UV detecting strip 320 can allow the biosensing device 100 to be utilized as an UV sensor. Similarly, in this embodiment, the microprocessor 111 executes the updated application software, which is updated through the in-system programming interface 121, to turn on the transmission gates I12, I22, I33, X11, X23, O11, O21, and O31 inside the routing matrix 130. In this way, the exciting voltage source 150 inputs an exciting voltage through the pin 2. And the signal received from the pin 3 is amplified by the sensing amplifier 160 and then transformed into a digital signal by the A/D converter 160. Therefore, the following processing module 110 can process the digital signal to know whether the UV sensing transistor is detected. Therefore, the UV detecting strip 320 can provide the function of sensing the UV light.

For the IR transmission strip 330, the IR transmission strip 330 can allow the biosensing device 100 to be utilized as an IR bi-directional transmitter. In this embodiment, the microprocessor 111 executes the updated application software, which is updated through the in-system programming interface I21, to operate the IR transmission strip 330. That is, the microprocessor 111 executes updated software to turn on the transmission gates I11, I23, I32, X11, X23, O12, O21, O31 inside the routing matrix 130. In this way, the IR LED is electrically connected to the processing module 110 to receive a digital signal from the microprocessor 111 and generates IR according to the digital signal. From the above disclosure, it can be seen that an IR transmission function can be achieved.

On the other hand, the IR sensor is electrically connected to the A/D converter 180 for translating an IR signal into an analog signal. And then, the A/D converter 180 can transform the analog signal into a digital signal and output the digital signal to the following processing module 110 to complete the IR receiving operation. From the above disclosure, it can be seen that the IR receiving function can be achieved. Therefore, the IR transmission strip 330 can achieve the IR bi-directional transmission function.

For the blood glucose testing strip 340, the microprocessor 111 executes the updated application software, which is updated through the in-system programming interface 121, to perform the following steps. First, the microprocessor 111 turns on the transmission gates I21, X22, and O21 to check whether the external voltage source (such as a battery voltage) Vcc is normal. And then, the microprocessor 111 turns on the transmission gate I22 for setting the voltage level provided by the exciting voltage source 150 to ensure that the voltage level is workable for the following electronic chemical reaction of the testing strip 340. Then, the microprocessor 111 turns on the transmission gates I11, I22, I33, X11, X23, O11, O31 and sets the gain value of the sensing amplifier 160 such that the voltage level provided by the exciting voltage source 150 can be transferred to the pins 1-2 of the testing strip 340. In this way, the testing strip 340 can start an electronic chemical reaction and generate a reaction result. The reaction result is amplified by the sensing amplifier 160 to generate an amplified signal. The A/D converter 180 transforms the amplified signal into a digital signal for the microprocessor 111 to process. At last, the microprocessor 111 turns on the transmission gates I31, X23, and O21 to utilize the temperature sensor 170 to detect the environment temperature and utilize the A/D converter 180 to transform the detection result of the temperature sensor into a digital temperature signal. In this way, the microprocessor 111 can process the digital signal and the digital temperature signal to obtain a final measurement result of the blood glucose.

For the blood glucose and uric acid testing strip 350, the microprocessor 111 executes the updated application software, updated through the in-system programming interface 121, to detect the measurement result of the blood glucose and/or the uric acid. Please note that, the method and operation of measuring the blood glucose are similar to those of the above-mentioned blood glucose testing strip 340, so in the following disclosure, the operation of the testing strip 350 will be simply illustrated.

In this embodiment, in order to measuring the uric acid, first, the microprocessor 111 turns on the transmission gates I21, X22, and O21 to check whether the external voltage source (voltage level of the external battery) Vcc is normal. Then, the microprocessor 111 turns on the transmission gate I22 for setting the voltage level provided by the exciting voltage source 150 to ensure that the voltage level is normal and is able to trigger the electronic chemical reaction of the testing strip 350. And then, the microprocessor 111 turns on the transmission gates I11, I22, I33, X23, O11, and O31 to transfer the voltage level provided by the exciting voltage source 150 to the pins 1-2 of the testing strip 350. In this way, the testing strip 350 can start an electronic chemical reaction in the blood glucose reaction area to measure the blood glucose such that a reaction result of the blood glucose is generated. The reaction result is amplified by the sensing amplifier 160 to generate an amplified signal. The A/D converter 180 transforms the amplified signal into a digital signal for the microprocessor 111 to process. Furthermore, the microprocessor 111 turns on the transmission gates I12, I22, I33, X11, X23, O11, and O31 and sets the gain value of the sensing amplifier 160 to transfer the voltage level provided by the exciting voltage source 150 to the pins 2-3 of the testing strip 350. In this way, the testing strip 350 can start an electronic chemical reaction of the uric acid in the uric acid reaction area to measure the uric acid. Therefore, a reaction result of the uric acid can be generated. Then, the sensing amplifier 160 also amplifies the reaction result of the uric acid and the A/D converter 180 transforms the output of the sensing amplifier 160 into another digital signal for the microprocessor 111 to process. At last, the microprocessor 111 turns on the transmission gates I31, X23, and O21 to utilize the temperature sensor 170 to detect the environment temperature and utilize the A/D converter 180 to transform the detection result of the temperature sensor into a digital temperature signal. In this way, the microprocessor 111 can process the digital signals corresponding to the blood glucose reaction/uric acid reaction results and the digital temperature signal to obtain the measurement results of the blood glucose and the uric acid.

As mentioned previously, because each of the transmission gates inside the routing matrix 130 can be turned on/off (switched) according to different circuit demands, the inner devices of the biosensing device 100 can have different combination (configurations) such that the biosensing device can have a better hardware flexibility. For example, the above-mentioned sensing amplifier 160 and the temperature sensor 170 can share the same A/D converter 180 by switching the inner transmission gates inside the routing matrix 130.

In addition, through appropriate arrangements, the biosensing device 100 can support the above-mentioned five different testing strips 310-350. Therefore, if the biosensing device 100 does not support each of the testing strips 310-350 when it is developed, when the testing strips need to be utilized, the application software stored in the memory 112 can be updated through the in-system programming interface 121 such that the updated biosensing device 100 becomes to support the testing strips 310-350.

Furthermore, as mentioned previously, as long as the new testing strip can work with the biosensing device 100 (this means that the pins of the new testing strip can comply with the pin interface of the biosensing device 100 and the original inner devices inside the biosensing device 100 are enough to support the new testing strip), the biosensing device 100 can be updated to support the new testing strip and to further provide other functions. Please note that, the present invention does not limit the implementations of the memory 112. For example, the memory 112 can be implemented as ROM, PROM, EPROM, or RAM.

In addition, the routing matrix 200 shown in FIG. 2 is only regarded as an embodiment, not a limitation of the present invention. In the actual implementation, the present invention can utilize all kinds of routing matrixs to determine the combination of the inner devices inside the biosensing device 100. This change also obeys the spirit of the present invention. For example, the transmission gates in the routing matrix 200 are utilized as switching devices. Therefore, the transmission gate can be replaced by a switch, a relay, or a transistor. In addition, the inner circuit of the routing matrix 200 can be implemented by jumper wires or a fixed circuit.

Please note that, the present invention does not limit the implementation of the in-system programming interface. That is, the above-mentioned JTAG interface is only regarded as an embodiment, not a limitation of the present invention. In the actual implementation, other interfaces or a self-defined interface can also be utilized. This change also obeys the spirit of the present invention.

In contrast to the prior art, the present invention biosensing device comprises an in-system programming interface capable of utilizing an external in-system programmer to update the application software inside the memory. Therefore, the present invention can support different kinds of testing strips or provide other functions (e.g: flashlight or IR transmission functions) after it is updated. For example, after the present invention biosensing device has already been developed, if a new testing strip appears, the present invention can support the new testing strip by updating the application software through the in-system programming interface as long as the new testing strip can work with the biosensing device (this means that the pins of the new testing strip can comply with the pin interface of the biosensing device and the original inner devices inside the biosensing device are enough for the new testing strip).

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A biosensing device for measuring a testing strip to generate a measurement result, the biosensing device comprising:
a sensors and actuators group;
a processing module comprising:
a storage device storing an application software; and
a processing unit, electrically connected to the storage device;
a routing matrix, comprising a plurality of connecting ends and a plurality of switch devices, the plurality of connecting ends are respectively electrically connected to the testing strip, the processing module, and the sensors and actuators group; and
an in-system programming interface, electrically connected to the processing module, for connecting to an in-system programmer to utilize the in-system programmer to update the application software;
wherein the processing unit executes the updated application software updated by the in-system programmer to control the plurality of switch devices inside the routing matrix to change electrical connections among the sensors and actuators group, the processing module, and the testing strip in order to utilize the sensors and actuators group to measure the testing strip and process a sensing result of the sensors and actuators group to generate the measuring result.

2. The biosensing device of claim 1, wherein the sensors and actuators group comprises an exciting voltage source, a sensing amplifier, a temperature sensor, and an analog-to-digital converter, respectively electrically connected to the connecting ends of the routing matrix; wherein the processing unit executes the application software updated through the in-system programming interface to controlling a combination of the exciting voltage source, the sensing amplifier, the temperature sensor, and the analog-to-digital converter through the routing matrix to measure the testing strip such that the measuring result is generated.

3. The biosensing device of claim 2, wherein the processing executes the application software updated through the in-system programming interface to control the exciting voltage source to trigger the testing strip to generate a reaction result, to control the sensing amplifier and the analog-to-digital converter to transform the action result into a digital signal, to control the temperature sensor and the analog-to-digital converter to generate a digital temperature signal, and to process the digital signal and the digital temperature signal to generate the measurement result.

4. The biosensing device of claim 1, wherein the processing unit is a microprocessor.

5. The biosensing device of claim 1, wherein the storage device is a memory.

6. The biosensing device of claim 5, wherein the memory is a read-only memory (ROM) or a random access memory (RAM).

7. The biosensing device of claim 1, wherein the in-system programming interface is a JTAG interface.

8. The biosensing device of claim 1, wherein the routing matrix comprises a fixed circuit.

9. The biosensing device of claim 1, wherein the routing matrix is implemented by jumper wires.

10. The biosensing device of claim 1, wherein the routing matrix is a programmable routing matrix.

11. The biosensing device of claim 1, wherein the switch devices are capable of being implemented by transistors, transmission gates, or relays.
